(19) United States
(12) Patent Application Publication
(10) Pub. No.: US 2017/0285803 A1
(43) Pub. Date: Oct. 5, 2017

(54) TOUCH WINDOW, TOUCH DEVICE AND METHOD FOR PRESS SENSING

(71) Applicant: LG INNOTEK CO., LTD., Seoul (KR)

(72) Inventors: Sang Young LEE, Seoul (KR); Soo Kwang YOON, Seoul (KR); Bo Ra KANG, Seoul (KR); Yu Won LEE, Seoul (KR)

(73) Assignee: LG INNOTEK CO., LTD.

(21) Appl. No.: 15/478,521

(22) Filed: Apr. 4, 2017

(30) Foreign Application Priority Data
Apr. 4, 2016 (KR) 10-2016-0041294
May 17, 2016 (KR) 10-2016-0060355

(51) Int. Cl. G06F 3/044

(52) U.S. Cl. CPC G06F 3/044; G06F 2203/04104; G06F 2203/04102; G06F 2203/04105

(57) ABSTRACT

A touch window is provided. The touch window may include a substrate including an effective region and an ineffective region and a plurality of pressure detection members provided in the ineffective region. The pressure detection members may be spaced apart from each other, and each of the pressure detection members may include a strain gauge or a capacitance detection electrode.

### CROSS-REFERENCE TO RELATED APPLICATIONS

This application claims priority under 35 U.S.C. §119 to Korean Patent Application Nos. 10-2016-0041294 filed on Apr. 4, 2016 and 10-2016-0060355 filed on May 17, 2016, whose entire disclosures are incorporated herein by reference.

### BACKGROUND

### 1. Field

Embodiments relate to a touch window, a touch device, and a method for press sensing.

### 2. Background

Touch windows, through which images displayed on a display device may be touched using an input device, such as, e.g., a finger or a stylus, have been applied to various electronic products. Such touch windows can be largely divided into a resistive touch window and a capacitive touch window. In a resistive touch window, a glass and an electrode may be short-circuited by pressure from an input device and a location of a contact point may be detected. A capacitive touch window senses a change in capacitance between electrodes when a touch device touches the touch window and a location of a contact point is detected.

In addition to position detection based on a touch, attention has been paid to a pressure sensor that senses pressure based on a force of a touch or detects an intensity of a pressure so as to perform various operations. In a display device formed with a combination of such a pressure sensor and such a touch window, there may be a problem in that a thickness thereof may be increased due to a structure of the pressure sensor being added to the touch window. Further, it may be difficult to recognize a pressure at each point when multi-touching at two points. Sensitivity for sensing a pressure may not be uniform according to touched locations, and thus accurate pressure recognition may be difficult.

### BRIEF DESCRIPTION OF THE DRAWINGS

The embodiments will be described in detail with reference to the following drawings in which like reference numerals refer to like elements wherein:

FIG. 1 is a top view illustrating a substrate of a touch window according to an embodiment;

FIG. 2 is a top view illustrating a substrate of a touch window according to an embodiment;

FIG. 3 is an exploded perspective view illustrating a touch device according to a first embodiment;

FIG. 4 is a top view illustrating a substrate of the touch device according to the first embodiment;

FIG. 5 is a cross-sectional view illustrating a region taken line A-A′ of FIG. 4;

FIG. 6 is a cross-sectional view illustrating the touch device according to the first embodiment;

FIG. 7 is another cross-sectional view illustrating the touch device according to the first embodiment;

FIG. 8 is a top view illustrating a substrate of another touch device according to the first embodiment;

FIG. 9 is a cross-sectional view illustrating a region taken line B-B′ of FIG. 8;

FIG. 10 is a cross-sectional view illustrating another touch device according to the first embodiment;

FIG. 11 is another cross-sectional view illustrating another touch device according to the first embodiment;

FIG. 12 is still another cross-sectional view illustrating another touch device according to the first embodiment;

FIG. 13 is a cross-sectional view illustrating still another touch device according to the first embodiment;

FIG. 14 is another cross-sectional view illustrating still another touch device according to the first embodiment;

FIG. 15 is still another cross-sectional view illustrating still another touch device according to the first embodiment;

FIG. 16 is a view illustrating various shapes of a pressure electrode pattern according to the first embodiment;

FIG. 17 is a cross-sectional view illustrating a touch device according to a second embodiment;

FIG. 18 is a view of a relationship between locations of a pressure detection electrode and a touch detection electrode according to the second embodiment;

FIGS. 19 and 20 are views for describing a method of measuring a pressure of the touch device according to the second embodiment;

FIG. 21 to FIG. 23 are cross-sectional views illustrating a touch device according to various embodiments; and

FIG. 24 to FIG. 28 are views illustrating examples of touch devices to which the touch device according to embodiments may be applied.

### DETAILED DESCRIPTION

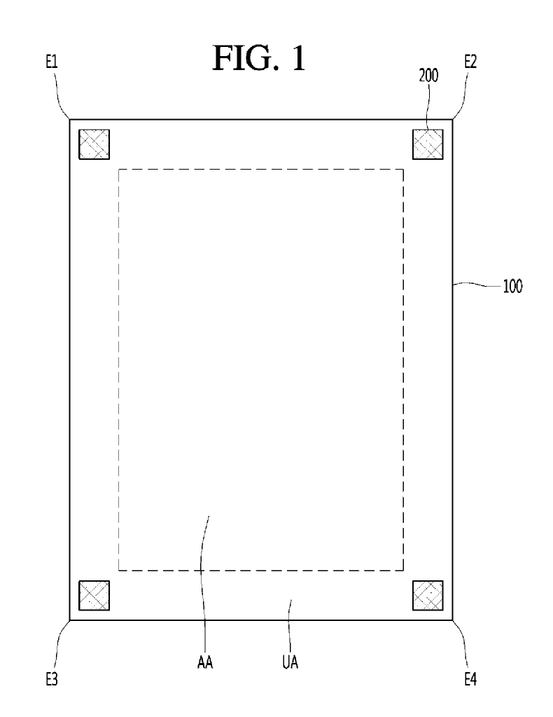

Referring to FIG. 1, a substrate 100 may be applied to a touch window or touch device. The substrate 100 may be rigid or flexible. For example, the substrate 100 may include glass or plastic. The substrate 100 may include chemically tempered or semi-tempered glass, such as soda lime glass or aluminosilicate glass, tempered or flexible plastic including polyimide (PI), polyethylene terephthalate (PET), propylene glycol (PPG), polycarbonate (PC), etc., or sapphire. The substrate 100 may include an isotropic optical film. For example, the substrate 100 may include cyclic olefin copolymer (COC), cyclic olefin polymer (COP), isotropic optical PC, isotropic optical polymethyl methacrylate (PMMA), etc.

Sapphire has excellent electrical characteristics, for example, dielectric constants, thereby easily implementing a spaced touch, such as, e.g., hovering or the like, in addition to significantly improving touch response time. Hovering refers to a technique of recognizing coordinates even at a short distance from a display. Since sapphire has high surface strength, sapphire may be a material capable of being used as a cover substrate.

A part of the substrate 100 may have a curved surface to be curved. A part of the substrate 100 may have a flat surface, and another part thereof may have a curved surface to be curved. An end portion of the substrate 100 may have a curved surface to be curved or have a surface including a random curvature to be curved or bent. The substrate 100 may be a flexible substrate having a flexible characteristic. The substrate 100 may be a curved or bent substrate. A touch window including the substrate 100 may also be formed to have a flexible, curved, or bent characteristic. Accordingly, the touch window may easily be made to be portable and may be changed into various designs.

An effective region AA and an ineffective region UA may be defined in the substrate 100. A display may operate in the effective region AA, and the display may not operate in the ineffective region UA provided around the effective region AA. Pressure and/or location of an input device, for example, a finger, a stylus pen, may be detected in at least one region of the effective region AA and the ineffective region UA. For example, a pressure detection member 200 may be provided in the ineffective region UA. A plurality of pressure detection members 200 may be provided in the ineffective region UA. The plurality of pressure detection members 200 spaced apart from each other may be provided in the ineffective region UA.

The pressure detection member may include a conductive material. For example, the pressure detection member may include a strain gauge. Alternatively, the pressure detection member may include at least one capacitance detection electrode of which capacitance is changed by an applied force. For example, referring to FIG. 1, the pressure detection member 200 may be provided in a corner region of the substrate 100. When the substrate 100 has a tetragonal shape, the pressure detection member 200 may be provided in at least one corner region among four corner regions of the substrate 100.

The substrate 100 may include a first corner region E1, a second corner region E2, a third corner region E3, and a fourth corner region E4. The pressure detection member 200 may be provided in the first corner region E1, the second corner region E2, the third corner region E3, or the fourth corner region E4. The pressure detection member 200 may be provided in at least one corner region among the first corner region E1, the second corner region E2, the third corner region E3, and the fourth corner region E4.

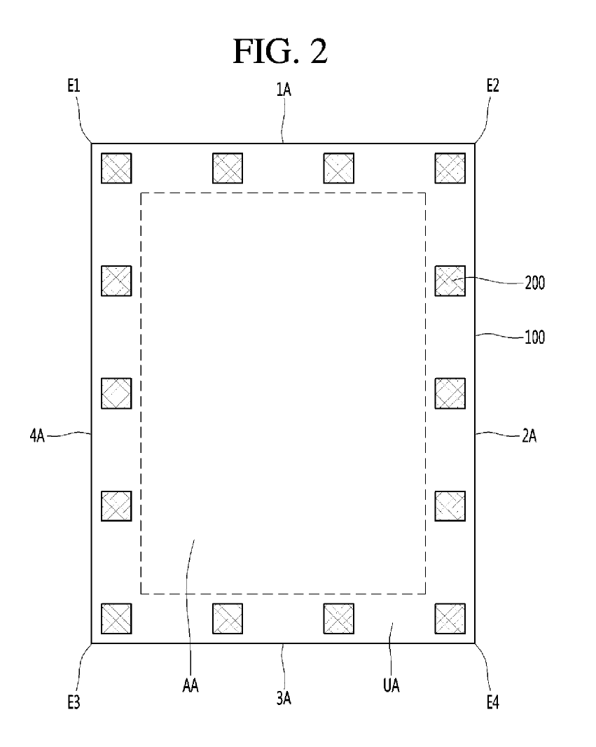

Alternatively, referring to FIG. 2, the pressure detection members 200 may be provided in an edge region of the substrate 100. The pressure detection members 200 may be provided to extend along the ineffective region UA of the substrate. Specifically, the pressure detection members 200 may be provided in a direction in which the ineffective region UA of the substrate 100 extends. The pressure detection members 200 may be provided to surround the effective region AA. The pressure detection members 200 may be spaced apart from each other and provided to surround the effective region AA of the substrate 100.

The substrate 100 may include the first corner region E1, the second corner region E2, the third corner region E3, and the fourth corner region E4. The substrate 100 may include a first region 1A between the first corner region E1 and the second corner region E2, a second region 2A between the second corner region E2 and the fourth corner region E4, a third region 3A between the third corner region E3 and the fourth corner region E4, and a fourth region 4A between the first corner region E1 and the third corner region E3.

The pressure detection member 200 may be provided in the first corner region E1, the second corner region E2, the third corner region E3, the fourth corner region E4, the first region 1A, the second region 2A, the third region 3A, or the fourth region 4A. The pressure detection member 200 may be provided in at least one region among the first corner region E1, the second corner region E2, the third corner region E3, the fourth corner region E4, the first region 1A, the second region 2A, the third region 3A, and the fourth region 4A.

One pressure detection member 200 may be provided in each of the first region 1A, the second region 2A, the third region 3A, and the fourth region 4A. The plurality of pressure detection members 200 may be provided in the first region 1A, the second region 2A, the third region 3A, and the fourth region 4A. One or multiple pressure detection members 200 may be provided in the first region 1A, the second region 2A, the third region 3A, and the fourth region 4A.

Referring to FIG. 1 and FIG. 2, although the pressure detection members 200 may be spaced a same distance from each other, the embodiment is not limited thereto, and the pressure detection members 200 may be provided to be spaced different distances or random distances from each other. The plurality of pressure detection members may be provided on the substrate. Thus, since the plurality of pressure detection members may be spaced apart from each other in multiple regions of the substrate instead of one region of the substrate, a location and intensity of a force applied to the touch window may be measured more accurately.

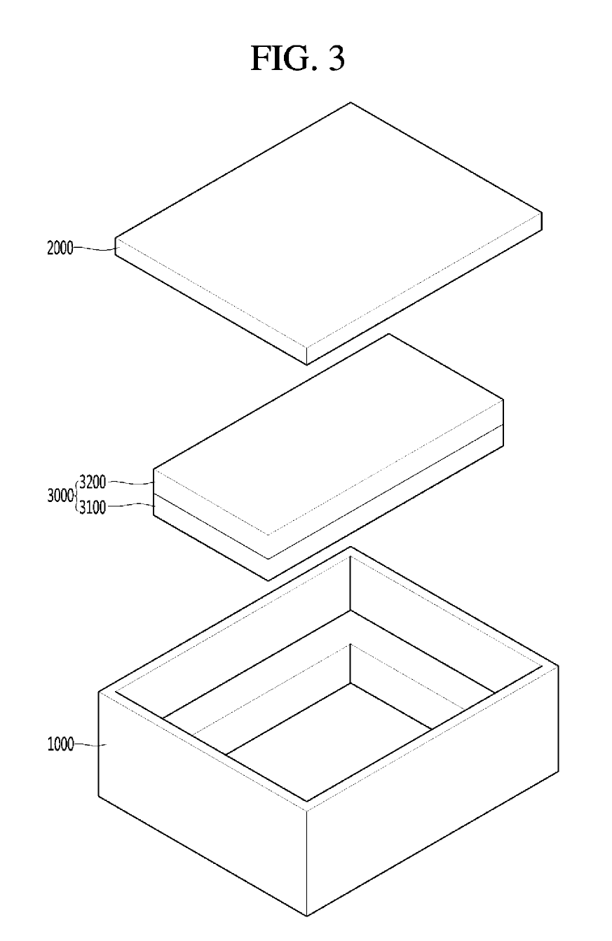

Referring to FIG. 3 to FIG. 7, a touch device according to an embodiment may include a cover case 1000, a touch window 2000, and a display panel 3000. The cover case 1000 may be configured to accommodate the display panel 3000 and the touch window. The touch window 2000 and the display panel 3000 may be provided inside the cover case 1000. The cover case 1000 may include a rigid or flexible material. For example, the cover case 1000 may include a metal or plastic. For example, the cover case 1000 may include a tempered or flexible plastic including PI, PET, PPG, PC, etc.

The cover case 1000 may be a middle frame. For example, the cover case 1000 may be a middle frame on which a plurality of components for driving the touch device may be mounted. The cover case 1000 may include a lower support 1100 and a side support 1200. The cover case 1000 may include the lower support 1100 and the side support 1200 bent from an edge region of the lower support 1100 to extend from the edge region. The lower support 1100 and the side support 1200 may be integrally formed.

The side support 1200 may extend in another direction that is different from a direction in which the lower support 1100 extends from an end portion of the lower support 1100, and may be bent from the lower support 1100. For example, the side support 1200 may be bent and extend from the end portion of the lower support 1100 so that an angle, such as a right angle, an acute angle, or an obtuse angle, is formed between the lower support 1100 and the side support 1200. Although the lower support 1100 has a tetragonal shape in the drawings, the embodiment is not limited thereto, and the lower support 1100 may be formed to have various shapes such as a circular shape and the like.

The side support 1200 may be formed to surround the edge region of the lower support 1100. The side support 1200 may include a first side support 1210 and a second side support 1220. For example, the side support 1200 may include the first side support 1210, which may be bent and extend from the edge region of the lower support 1100, and the second side support 1220 formed to extend in a direction in which the first side support 1210 extends from the first side support 1210.

The first side support 1210 and the second side support 1220 may be integrally formed. The first side support 1210 and the second side support 1220 may be formed to have different widths. A width W1 of the first side support 1210 may be greater than a width W2 of the second side support 1220. Accordingly, a part of an upper surface of the first side support 1210 may be exposed. The first side support 1210 and the lower support 1100 may be formed to have a step. A side surface of the second side support 1220 may be exposed.

The display panel 3000 may be provided inside the cover case 1000. For example, the display panel 3000 may be provided on the lower support 1100 inside the cover case 1000. The display panel 3000 may include a first substrate 3100 and a second substrate 3200. When the display panel 3000 is a liquid crystal display panel, the display panel 3000 may be formed to have a structure in which the first substrate 3100, which includes a thin film transistor (TFT) and a pixel electrode, and the second substrate 3200, which includes color filter layers, may be adhered to each other with a liquid crystal layer interposed therebetween.

The display panel 3000 may be a liquid crystal display panel having a color filter on transistor (COT) structure in which a TFT, a color filter, and a black matrix may be formed on the first substrate 3100 and the second substrate 3200 and the first substrate 3100 may be adhered to each other with a liquid crystal layer interposed therebetween. A TFT may be formed on the first substrate 3100, a protective film may be formed on the TFT, and a color filter layer may be formed on the protective film. A pixel electrode in contact with the TFT may be formed on the first substrate 3100. At this time, a black matrix may be omitted to improve an opening ratio and simplify a mask process, and a common electrode may be formed to serve as the black matrix.

When the display panel 3000 is a liquid crystal display panel, the display device may further include a backlight unit which provides light to a rear surface of the display panel 3000. When the display panel 3000 is an organic electroluminescence display panel, the display panel 3000 may include a self-light emitting element which does not need a separate light source. In the display panel 3000, a TFT may be formed on the first substrate 3100, and an organic light emitting element in contact with the TFT may be formed thereon. The organic light emitting element may include a positive electrode, a negative electrode, and an organic light emitting layer formed between the positive electrode and the negative electrode. The display panel 3000 may further include the second substrate 3200, which may serve as an encapsulating substrate for encapsulation, provided on the organic light emitting element.

The touch window 2000 may be provided inside the cover case 1000. The touch window 2000 may include the substrate 100 and the pressure detection member 200. The substrate 100 may be provided inside the cover case 1000. The substrate 100 may be accommodated inside the cover case 1000. The substrate 100 may be provided on the display panel 3000 inside the cover case 1000. The substrate 100 and the display panel 3000 may be provided to be adhered to each other. For example, the substrate 100 and the display panel 3000 may be provided to be adhered to each other using an optically clear adhesive (OCA) or an optically clear film (OCF).

The substrate 100 may be rigid or flexible. The substrate may include a material which may be the same as or similar to that of the above-described substrate of FIG. 1 and FIG. 2. Electrodes may be provided on the substrate 100. The pressure detection member 200 may be provided in the ineffective region UA. For example, a deco layer 300 may be provided in the ineffective region UA of the substrate 100.

The deco layer 300 may be formed with a material having a predetermined color capable of hiding a wiring electrode provided in the ineffective region, a printed circuit board through which the wiring electrode is connected to an external circuit, and the like from the outside. The deco layer 300 may have a color suitable for a desired exterior and, for example, may include a black or white pigment to display black or white. The deco layer 300 may use various color films to display various colors such as red, blue, etc. A desired logo or the like may be formed on the deco layer 300 using various methods. The deco layer 300 may be formed by deposition, printing, wet coating, bonding, etc. The deco layer 300 may be provided to have at least one layer. For example, the deco layer 300 may be provided as one layer or may be provided as at least two layers having different widths.

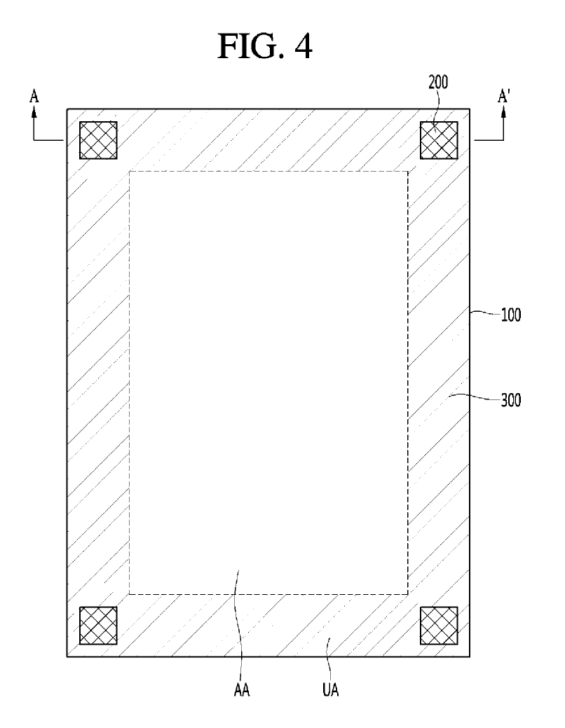

Referring to FIG. 4, at least one pressure detection member 200 may be provided in the ineffective region UA. The plurality of pressure detection members 200 may be provided in the ineffective region UA. The plurality of pressure detection members 200 spaced apart from each other may be provided in the ineffective region UA. For example, the deco layer 300 may be provided in the ineffective region UA of the substrate 100, and the pressure detection member 200 may be provided on the deco layer 300 to be in direct or indirect contact with the deco layer 300. The pressure detection members 200 may be provided to be spaced apart from each other in at least one region among the above-described corner regions of the substrate 100 of FIG. 1.

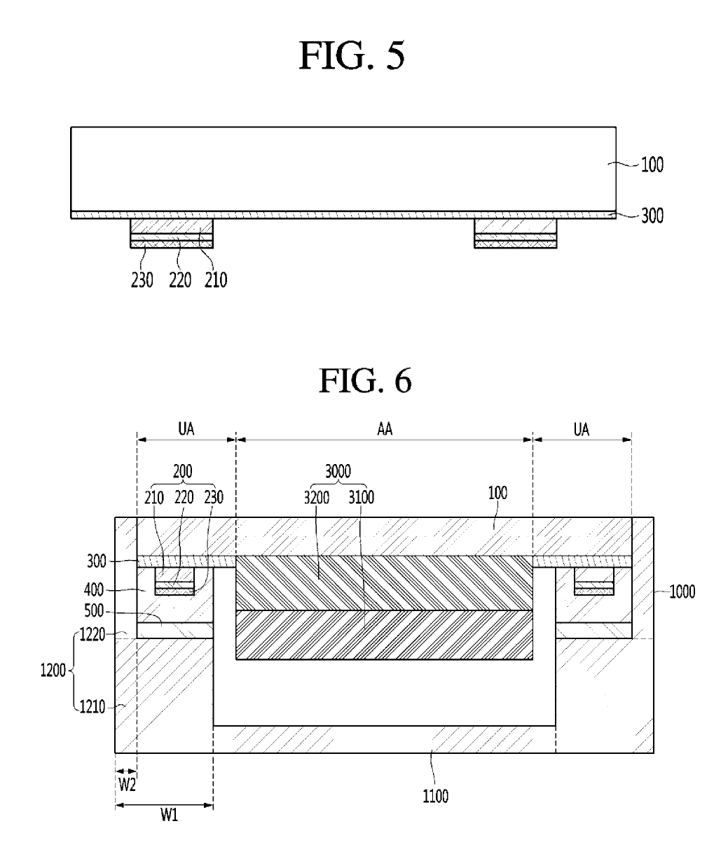

Referring to FIG. 5, the pressure detection member 200 may include a base substrate 210, a pressure electrode 220 provided on the base substrate 210, and a protective layer 230 provided on the pressure electrode 220. For example, the pressure detection member 200 may be a strain gauge. The strain gauge may be made by forming a metal thin film in a lattice state on a thin electrical insulator formed of a resin using a photoresist etching process, and may have a gauge lead including a lead cable attached thereto.

Generally, an electrical resistor has resistance which blocks a current, and a value of the resistor depends on a material thereof, but the value is generally high when a thickness thereof is small and a length thereof is great. Accordingly, when the resistor is pulled, resistance thereof is increased because the resistor is thinned and elongated, and when the resistor is pressed, the resistance thereof is decreased inversely. As the strain gauge may be made using the above principle, the resistance of the strain gauge may be changed by a pressure applied by the input device, and thus a change in the pressure may be detected on the basis of a change in the resistance.

The base substrate 210 may include plastic. The base substrate 210 may be flexible. For example, the base substrate 210 may include a material which is the same as or similar to that of the above-described substrate 100. For example, the base substrate 210 may include sapphire or a tempered or flexible plastic including PI, PET, PPG, PC, etc.

The pressure electrode 220 may be provided on the base substrate 210. The pressure electrode 220 may be provided to be in direct or indirect contact with the base substrate 210. The pressure electrode 220 may include a conductive material. For example, the pressure electrode 220 may include a metal oxide such as indium tin oxide, indium zinc oxide, copper oxide, tin oxide, zinc oxide, titanium oxide, etc. The pressure electrode 220 may include a nanowire, a photosensitive nanowire film, a carbon nanotube (CNT), graphene, a conductive polymer, or a mixture thereof. Alternatively, the pressure electrode 220 may include various metals. For example, the pressure electrode 220 may include at least one metal among chromium (Cr), nickel (Ni), copper (Cu), aluminum (Al), silver (Ag), molybdenum (Mo), gold (Au), titanium (Ti), and an alloy thereof.

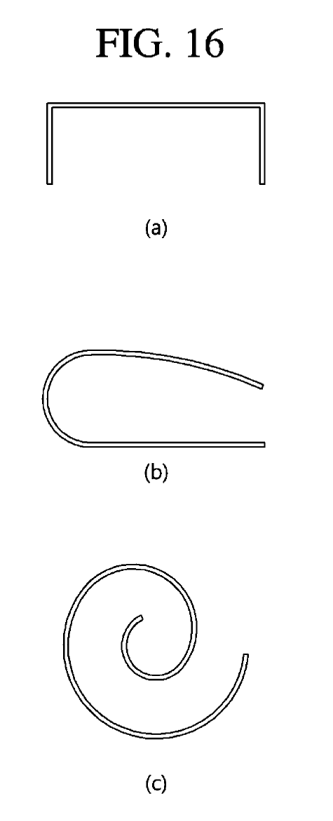

The pressure electrode 220 may be formed to have a plurality of patterns. The pressure detection electrode 220 may include a plurality of pressure electrode patterns spaced apart from each other. The pressure electrode patterns may be formed in various shapes. For example, the pressure electrode patterns may be formed in a bar shape. The pressure electrode patterns may include a curved surface. The pressure electrode patterns may be formed in a coil shape. However, embodiments are not limited thereto, the pressure electrode patterns may be formed in various shapes capable of detecting pressure, and a pressure may be detected by a change in an area or height of the pressure electrode pattern. For example, referring to FIG. 16, the pressure electrode patterns may be formed to be curved in at least one direction. Alternatively, the pressure electrode patterns include a curved surface to be bent. Alternatively, the pressure electrode patterns may be formed to extend in a roll shape, i.e., a coil shape.

The protective layer 230 may be provided on the pressure electrode 220. For example, the protective layer 230 may be provided to be in direct or indirect contact with the pressure electrode 220. The protective layer 230 may include a resin material. For example, the protective layer 230 may include at least one resin among an acrylic resin, a silicone resin, a urethane resin, and an epoxy resin.

Referring to FIG. 6, a resin layer 400 may further be provided in a region corresponding to the ineffective region of the substrate 100. The resin layer 400 may be provided in a region spaced apart from the cover case corresponding to the ineffective region of the substrate. The resin layer 400 may be provided to surround the pressure detection member 200. Accordingly, damage or deformation of the pressure detection member 200 exposed to the outside may be prevented. The resin layer 400 may include a material having elasticity. The resin layer 400 may include at least one resin among an acrylic resin, a silicone resin, a urethane resin, and an epoxy resin.

An adhesive layer 500 may be provided on an upper surface of the second side support 1220. The adhesive layer 500 may be provided to be adhered to the resin layer 400. The pressure detection member 200 may be fixed inside the cover case 1000 by the adhesive layer 500. However, the adhesive layer 500 may be omitted. A separate adhesive layer may be omitted by providing the resin layer 400 with an adhesive characteristic, and the pressure detection member 200 may be fixed inside the cover case 1000 by the resin layer 400.

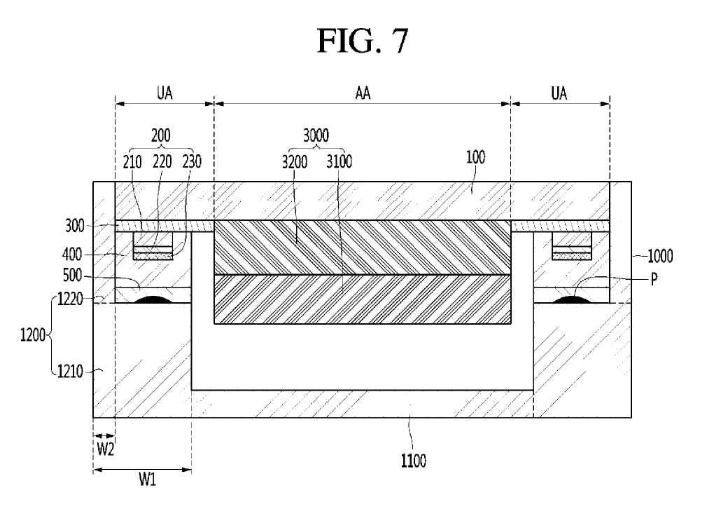

Referring to FIG. 7, a protrusion P may be formed on the upper surface of the first side support 1210. The protrusion P may be provided in a region of the first side support 1210 corresponding to a region in which the pressure detection member 200 is provided. The protrusion P may be integrally formed with the cover case 1000. The protrusion P may be integrally formed with the first side support 1210. The protrusion P may be formed in various shapes. The protrusion P may be formed in various shapes, such as, e.g., a hemispherical shape, a tetragonal shape, a triangular shape.

Sensitivity based on a pressure of the pressure detection member 200 may be improved by the protrusion P. When the protrusion P is provided in a region corresponding to the pressure detection member 200 and an input device applies a force or pressure to the substrate, the pressure detection member 200 comes into contact with the protrusion P, and thus sensitivity and accuracy of the pressure detection member 200 can be improved.

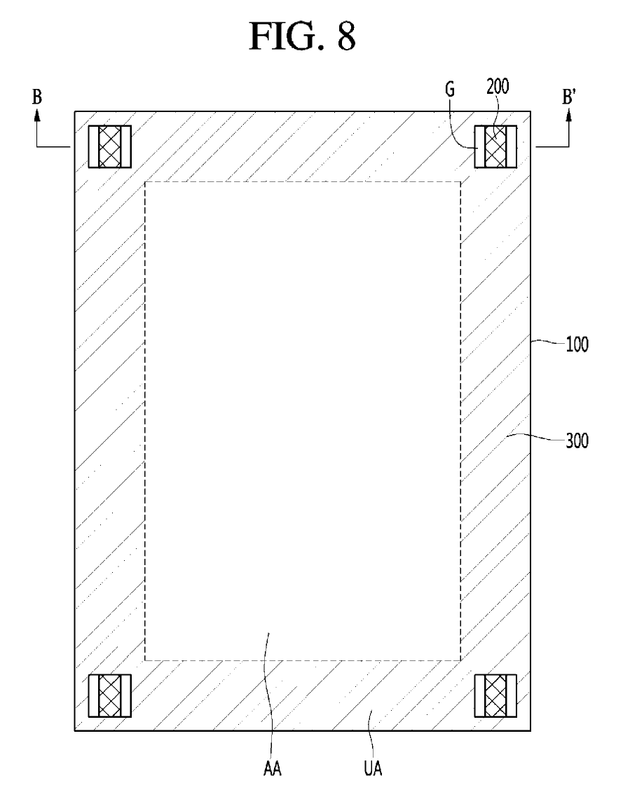

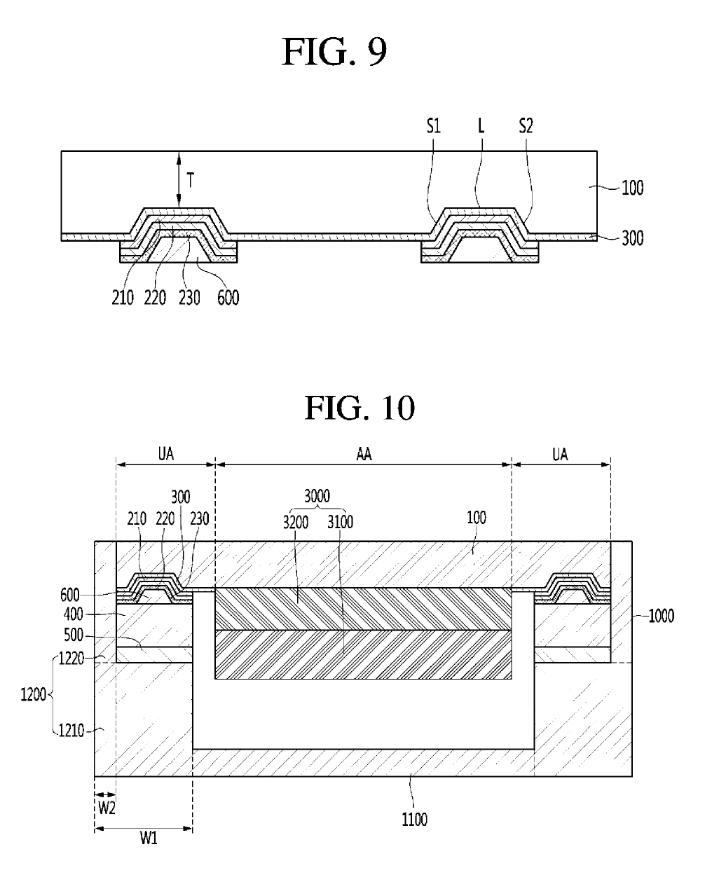

Referring to FIGS. 8 and 9, grooves G may be formed in the substrate 100. The plurality of grooves G may be formed in the ineffective region of the substrate 100. The substrate 100 may include a first surface to which a touch and/or force is applied by the input device and a second surface opposite the first surface. The grooves G may be formed in the second surface.

The grooves G may be formed by etching a part of the second surface. Accordingly, the groove G may include a first inside surface S1, a second inside surface S2, and a lower surface L. The lower surface L may connect the first inside surface S1 and the second inside surface S2. The first inside surface S1, the second inside surface S2, and the lower surface L may be formed to be connected to each other.

At least one inside surface of the first inside surface S1 and the second inside surface S2 may be formed to have a slope with respect to the lower surface L. For example, referring to FIG. 7, the first inside surface S1 and the second inside surface S2 may be formed to have a slope with respect to the lower surface L. However, embodiments are not limited thereto, and at least one inside surface of the first inside surface S1 and the second inside surface S2 may also be formed to extend in a direction perpendicular to the lower surface L.

The first inside surface S1 may be formed to have a slope with respect to the lower surface L. For example, the first inside surface S1 may be formed to have a slope having a first angle with respect to the lower surface L. The second inside surface S2 may be formed to have a slope with respect to the lower surface L. For example, the second inside surface S2 may be formed to have a slope having a second angle with respect to the lower surface L. At least one angle of the first angle and the second angle may be an obtuse angle. At least one inside surface of the first inside surface S1 and the second inside surface S2 may be inclined at an obtuse angle with respect to the lower surface L.

Referring to FIG. 9, the first inside surface S1 and the second inside surface S2 may be inclined at an obtuse angle with respect to the lower surface L. The first angle and the second angle may be inclined at the same angle, similar angles to each other, or different angles from each other.

A width W of the groove G may be different at a location of each of the grooves G. The width W of the groove G may be increased in a direction from the lower surface L of the groove G to the first surface of the substrate 100. The width W of the groove G may be changed according to a size of the pressure detection member 200 or the like accommodated inside the groove G.

A thickness of the substrate 100 may be in a range of about 500 μm to 600 μm. A distance from the first surface of the substrate 100 to the second surface of the substrate 100 may be in a range of about 500 μm to 600 μm. The groove G may be formed to have a height which is about 50% or more the thickness of the substrate 100.

A distance T from the lower surface L of the groove G to the first surface of the substrate 100 may be about 300 μm or less. The distance T from the lower surface L of the groove G to the first surface of the substrate 100 may be in a range of about 100 μm to 300 μm. The distance T from the lower surface L of the groove G to the first surface of the substrate 100 may be in a range of about 150 μm to 300 μm.

When the distance T from the lower surface L of the groove G to the first surface of the substrate 100 is less than about 100 μm, a depth of the groove G may be increased, and thus overall strength of the substrate 100 may be reduced and reliability thereof may be degraded. When the distance T from the lower surface L of the groove G to the first surface of the substrate 100 is greater than about 300 μm, a distance from the first surface of a substrate to a fingerprint sensor 500 may be increased, and thus sensitivity of recognition based on a fingerprint touch may be degraded.

The pressure detection members 200 may be provided inside the grooves G. The deco layer 300 may be provided in the grooves G, and the pressure detection member 200 may be provided on the deco layer 300. The deco layer 300 may be provided to be in contact with the first inside surface S1, the second inside surface S2, and the lower surface L of the groove G. The pressure detection member 200 may be provided to extend in the same direction as a direction in which the deco layer 300 extends. The pressure detection member 200 may be provided in a region corresponding to a region in which the deco layer 300 is provided. The pressure detection member 200 may be provided to extend in the same direction as the direction in which the deco layer 300 extends. The groove G may be a receiving groove in which the deco layer 300 and the pressure detection member 200 are accommodated.

A sealing layer 600 may be provided on the protective layer 230. The sealing layer 600 may be provided to fill a step between the pressure detection member 200 and the groove G. A size of the step between the pressure detection member 200 and the groove G may be decreased by the sealing layer 600, and the sealing layer 600 may protect the pressure detection member 200 from external impacts and impurities. The sealing layer 600 may include a resin material. For example, the sealing layer 600 may include at least one resin among an acrylic resin, a silicone resin, a urethane resin, and an epoxy resin.

Referring to FIG. 10, a resin layer 400 may further be provided in a region corresponding to the ineffective region of the substrate 100. The resin layer 400 may be provided in a region spaced apart from the cover case corresponding to the ineffective region of the substrate. The resin layer 400 may be provided on the pressure detection member 200. The resin layer 400 may be provided to surround the pressure detection member 200. The pressure detection member 200 may be provided to be in direct or indirect contact with the resin layer 400. Accordingly, damage or deformation of the pressure detection member 200 may be prevented. The resin layer 400 may include at least one resin among an acrylic resin, a silicone resin, a urethane resin, and an epoxy resin.

The adhesive layer 500 may be provided on the upper surface of the second side support 1220. The adhesive layer 500 may be provided to be adhered to the resin layer 400. The pressure detection member 200 may be fixed inside the cover case 1000 by the adhesive layer 500. However, the adhesive layer 500 may be omitted. A separate adhesive layer may be omitted by providing the resin layer 400 with an adhesive characteristic, and the pressure detection member 200 may be fixed inside the cover case 1000 by the resin layer 400.

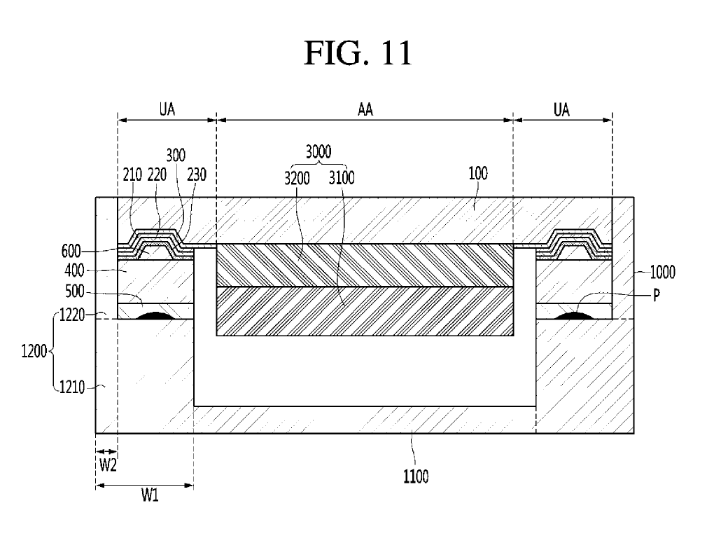

Referring to FIG. 11, a protrusion P may be formed on the upper surface of the first side support 1210. The protrusion P may be provided in a region of the first side support 1210 corresponding to a region in which the pressure detection member 200 is provided. The protrusion P may be integrally formed with the cover case 1000. The protrusion P may be integrally formed with the first side support 1210. The protrusion P may be formed in various shapes. For example, the protrusion P may be formed in various shapes, such as, e.g., a hemispherical shape, a tetragonal shape, a triangular shape.

Sensitivity based on a pressure of the pressure detection member 200 may be improved by the protrusion P. When the protrusion P is provided in a region corresponding to the pressure detection member 200 and an input device applies a force or pressure to the substrate, the pressure detection member 200 may come into contact with the protrusion P, and thus sensitivity and accuracy of the pressure detection member 200 can be improved.

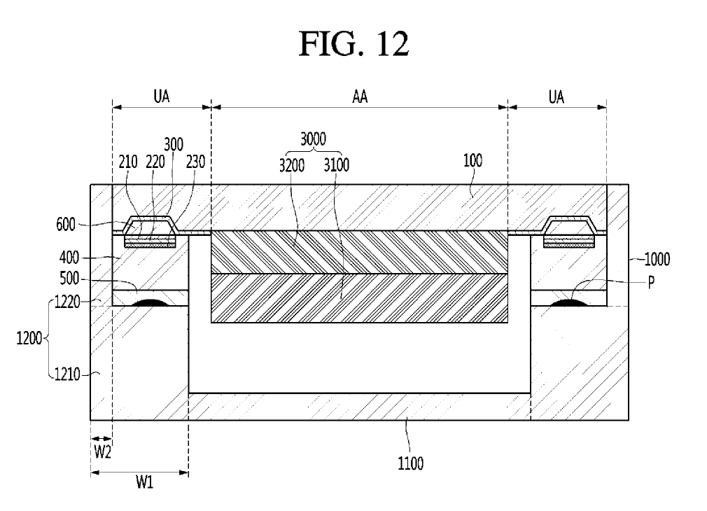

Referring to FIG. 12, a protrusion P may be formed on the upper surface of the first side support 1210, which may be the same as or similar to that of FIG. 9. The protrusion P may be provided in a region of the first side support 1210 corresponding to a region in which the pressure detection member 200 is provided.

A deco layer 300 may be provided in the groove G of the substrate 100, and a sealing layer 600 may be provided on the deco layer 300 to fill a step of the groove G. A pressure detection member 200 may be provided on the sealing layer 600. The pressure detection member 200 may be formed on a surface of the substrate on which a step is not formed, thereby preventing cracks of the pressure detection member 200 and improving reliability.

A touch electrode may be provided in the effective region AA of the substrate 100. A location of the input device may be detected in the effective region AA. When the input device comes into contact with the effective region, a capacitance difference between touch electrodes at portions in contact with the input device may be generated, and portions in which the difference is generated may be detected as contact locations.

The touch electrode may include a first touch detection electrode and a second touch detection electrode. The touch detection electrode may include a transparent conductive material so that transmission of light is not blocked and a current flows therethrough. For example, the touch detection electrode may include a metal oxide such as indium tin oxide, indium zinc oxide, copper oxide, tin oxide, zinc oxide, titanium oxide, etc. When a flexible and/or bent touch device is manufactured, a degree of freedom thereof may be improved.

Alternatively, the touch detection electrode may include a nanowire, a photosensitive nanowire film, a CNT, graphene, a conductive polymer, or a mixture thereof. When a flexible and/or bent touch device is manufactured, a degree of freedom thereof may be improved. When a nano-composite, such as a nanowire or CNT, is used, black may be displayed, and it may be advantageous for securing electrical conductivity and controlling color and reflectivity by controlling content of a nano-powder.

Alternatively, the touch detection electrode may include various metals. For example, the touch electrode may include at least one metal among chromium (Cr), nickel (Ni), copper (Cu), aluminum (Al), silver (Ag), molybdenum (Mo), gold (Au), titanium (Ti), and an alloy thereof. When a flexible and/or bent touch device is manufactured, a degree of freedom thereof may be improved.

The touch detection electrode may be provided in a mesh shape. For example, the touch electrode may include a plurality of sub electrodes provided to intersect each other, and the entire touch electrode may be provided in a mesh shape by the sub electrodes. Since the touch detection electrode has a mesh shape, a pattern of the touch electrode may be hidden in the effective region. Even when the touch electrode is formed of a metal, the pattern may be hidden. Even when the touch electrode is applied to a large touch window, resistance of the touch window may be reduced.

The touch detection electrode may include mesh wires formed by the plurality of sub electrodes which intersect each other and mesh openings between the mesh wires. A width of the mesh wire may be in a range of about 0.1 μm to 10 μm. It is impossible to make a mesh wire having a width that is less than about 0.1 μm, and when the width is greater than about 10 μm, a detection electrode pattern may be exposed to the outside, thereby degrading visibility. The width of the mesh wire may be in a range of about 1 μm to 5 μm. The width of the mesh wire may be in a range of about 1.5 μm to 3 μm.

A thickness of the mesh wire may be in a range of about 100 nm to 500 nm. When the thickness of the mesh wire is less than about 100 nm, electrode resistance may be increased and an electrical characteristic may be degraded, and when the thickness is greater than about 500 nm, a thickness of the entire touch window is increased, and process efficiency may be degraded. The thickness of the mesh wire may be in a range of about 150 nm to 200 nm. More preferably, the thickness of the mesh wire may be in a range of about 180 nm to 200 nm.

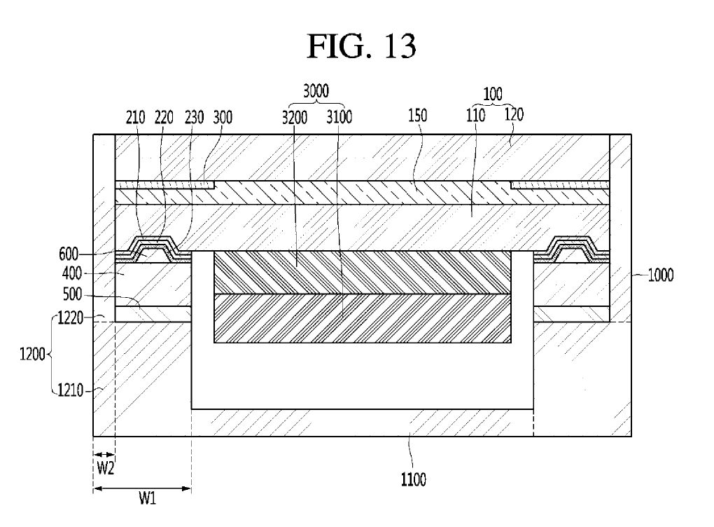

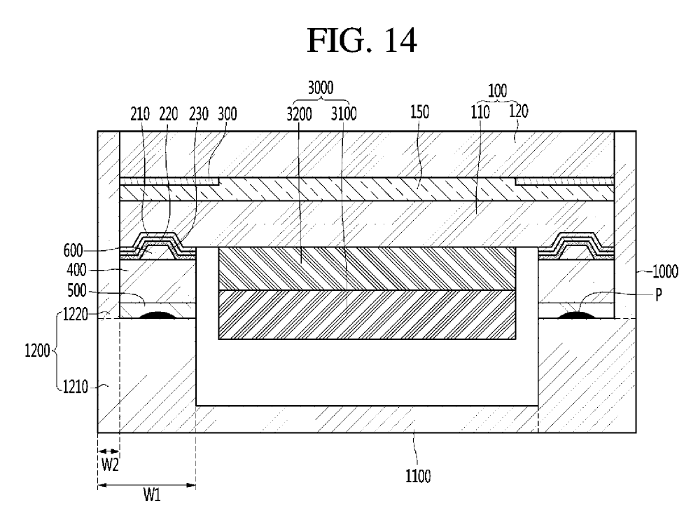

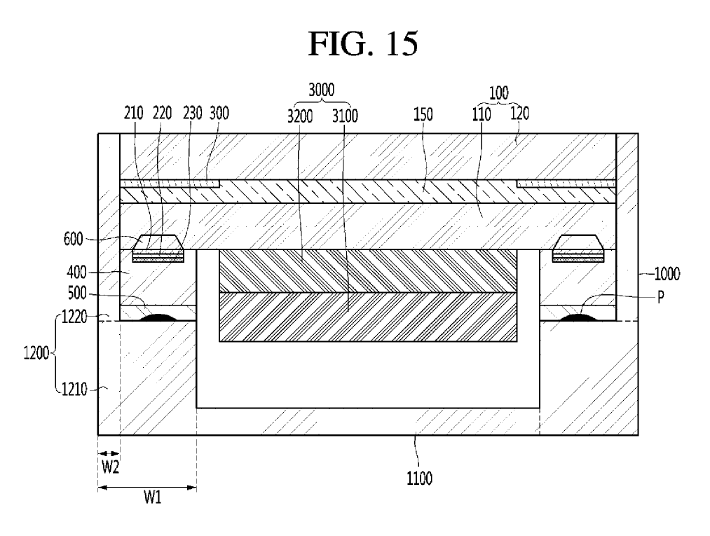

Referring to FIG. 13 to FIG. 15, a touch window according to still another embodiment may include a substrate 100. The substrate 100 may include at least two substrates. The substrate 100 may include a first' substrate 110 and a second' substrate 120 provided on the first' substrate 110. The first' substrate 110 and the second' substrate 120 may include a material which is the same as or similar to that of the above-described substrate 100. The first' substrate 110 and the second' substrate 120 may be provided to have thicknesses which may be the same or similar to each other.

An adhesive member 150 may be interposed between the first' substrate 110 and the second' substrate 120. The adhesive member 150 may be transparent. The first' substrate 110 and the second' substrate 120 may be adhered to each other by the adhesive member 150.

Grooves may be formed in the first' substrate 110 as in the above-described substrate 100. The deco layer 300 may be provided on the second' substrate 120. The deco layer 300 may be provided on the second' substrate 120 corresponding to a location of the groove.

Since the following structure may be the same as or similar to that described with reference to FIG. 10 to FIG. 12, a detailed description thereof has been omitted. The touch window according to still another embodiment may include at least two substrates. Even when the second' substrate in contact with the input device is damaged, a pressure detection member may be operated. Accordingly, reliability of the touch window may be improved.

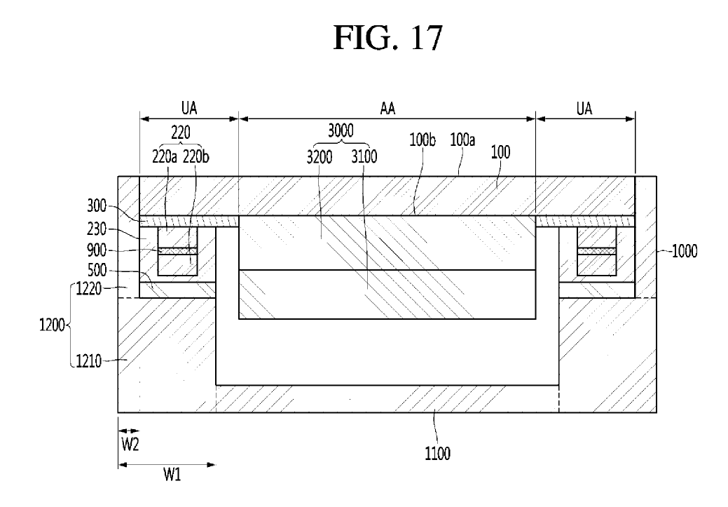

Hereinafter, a touch window and a touch device including the touch window according to a second embodiment will be described with reference to FIG. 17 to FIG. 20. When describing the touch window and touch device according to the second embodiment, descriptions which may be the same as or similar to the descriptions of the above-described touch window and touch device according to the first embodiment have been omitted, and a same drawing number has been assigned to same components.

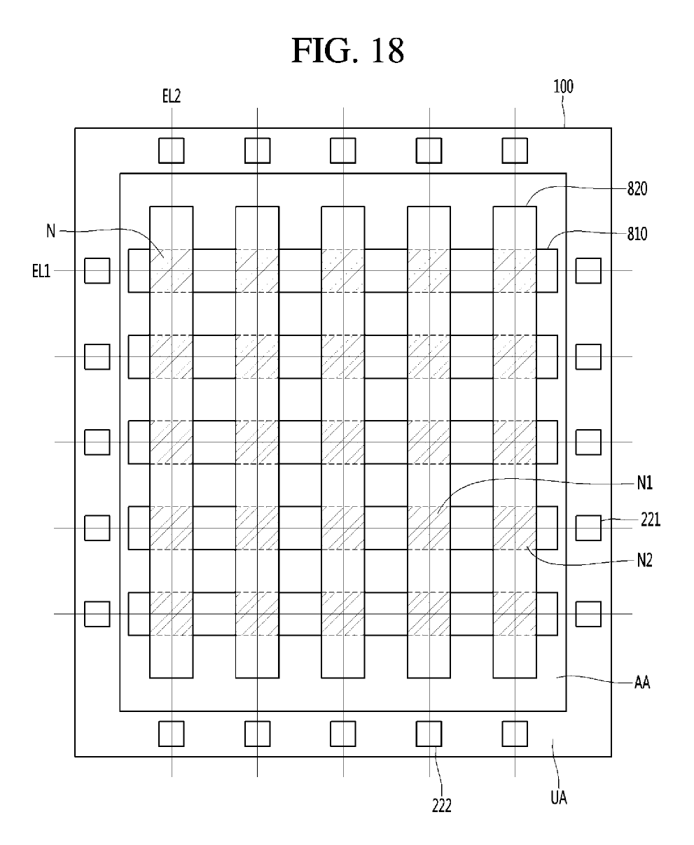

Referring to FIG. 17 to FIG. 20, the touch window according to the embodiment may include a substrate 100, touch detection electrodes 810 and 820, and a pressure detection electrode 220. Referring to FIG. 18, the touch detection electrodes may be provided in an effective region AA. A first touch detection electrode 810 which extends in one direction thereof and a second touch detection electrode 820 which extends in another direction that is different from the one direction of the first touch detection electrode 810 may be included in the effective region. The first touch detection electrode 810 and/or the second touch detection electrode 820 may include a transparent conductive material so that transmission of light is not blocked and a current flows therethrough, and may include above-described materials.

The first touch detection electrode 810 and the second touch detection electrode 820 may be provided on the substrate 100. The touch detection electrode may be provided in the effective region AA of the substrate 100. The first touch detection electrode 810 and the second touch detection electrode 820 may be provided on the same surface of the substrate 100. Alternatively, another substrate, for example, a first substrate, may further be provided on the substrate, the first touch detection electrode 810 may be provided on a surface of the substrate, and the second touch detection electrode 820 may be provided on a surface of the first substrate.

A wiring electrode connected to the touch detection electrode may further be included in an ineffective region of the substrate 100. The wiring electrode may include a conductive material. For example, the wiring electrode may include a conductive material which is the same as or different from that of the above-described detection electrode.

The touch detection electrode may form a node region. The node region may be defined as a region at which a location may be detected by the touch detection electrode. The node region may be defined as a location of a region in which the input device applies a pressure to a surface of the cover substrate. For example, the node region may be defined as a region in which a location may be detected by at least one touch detection electrode of the first touch detection electrode 810 and the second touch detection electrode 820.

For example, the first touch detection electrode 810 and the second touch detection electrode 820 may extend in different directions from each other and may intersect each other. The first touch detection electrode 810 and the second touch detection electrode 820 may form a plurality of node regions N in a region in which the first touch detection electrode 810 and the second touch detection electrode 820 intersect. For example, the first touch detection electrode 810 and the second touch detection electrode 820 may include a plurality of node regions spaced apart from each other in a matrix form.

When a location is detected by a mutual-cap method using the first touch detection electrode 810 and the second touch detection electrode 820 as described above, the node region N may be defined as a region in which the first touch detection electrode 810 and the second touch detection electrode 820 intersect. However, the embodiment is not limited thereto, and when a location is detected by a self-cap method using the first touch detection electrode 810 or the second touch detection electrode 820, the node region N may be defined as a region in which the location is detected by the first touch detection electrode 810 or the second touch detection electrode 820.

Hereinafter, a case in which a location is detected by the mutual-cap method using the first touch detection electrode 810 and the second touch detection electrode 820 will be described as an example. The node regions N may form virtual extension lines. The node regions N may include a first virtual extension line which extends in a direction in which the first touch detection electrode 810 extends and a second virtual extension line which extends in a direction in which the second touch detection electrode 820 extends.

A direction of a first extension line EL1 may be the same as or similar to the direction in which the first touch detection electrode 810 extends, and a direction of a second extension line EL2 may be the same as or similar to the direction in which the second touch detection electrode 820 extends.

The pressure detection electrodes 220 may be provided in an ineffective region UA. The pressure detection electrode 220 may be provided in the ineffective region UA at a location corresponding to each of the first extension line EL1 and the second extension line EL2. For example, the pressure detection electrode 220 may include a first pressure detection electrode 221 and a second pressure detection electrode 222. The pressure detection electrode 220 may include a plurality of first pressure detection electrodes 221 provided at locations which are included in the ineffective region and correspond to the first extension lines EL1. The pressure detection electrode 220 may include a plurality of second pressure detection electrodes 222 provided at locations which are included in the ineffective region and correspond to the second extension lines EL2.

The first pressure detection electrodes 221 may be provided in the ineffective region UA corresponding to an extension line in the direction in which the first touch detection electrode 810 extends, and the second pressure detection electrodes 222 may be provided in the ineffective region UA corresponding to an extension line in the direction in which the second touch detection electrode 820 extends.

Such a touch window may be coupled to a cover case 1000 and a display panel 3000 and may be applied to a touch device. The cover case 1000 may be configured to accommodate the display panel 3000 and the touch window. The display panel 3000 and the touch window may be provided inside the cover case 1000.

The above-described touch detection electrode may be provided on the display panel 3000. The first touch detection electrode 810 and the second touch detection electrode 820 may be provided inside the display panel 3000. For example, the touch detection electrode may be interposed between a first substrate 3100 and a second substrate 3200. Alternatively, the first touch detection electrode 810 and the second touch detection electrode 820 may be provided on the substrate 100 and the display. For example, the first touch detection electrode 810 may be provided in the effective region AA of the substrate 100, and the second touch detection electrode 820 may be provided on the second substrate 3200 of the display panel 3000.

Referring to FIG. 17, the pressure detection electrode 220 may include a first sub pressure detection electrode 220a and a second sub pressure detection electrode 220b. An insulating layer 900 may be interposed between the first sub pressure detection electrode 220a and the second sub pressure detection electrode 220b, and the first sub pressure detection electrode 220a and the second sub pressure detection electrode 220b may be insulated from each other.

The insulating layer 900 may include a resin-based insulating material. For example, the insulating layer 900 may include at least one resin such as an acrylic resin, a silicone resin, a urethane resin, and an epoxy resin. The insulating layer 900 may be rigid. Accordingly, a distance between the first sub pressure detection electrode 220a and the second sub pressure detection electrode 220b may be constantly maintained, and accordingly, the first sub pressure detection electrode 220a may be utilized as a ground electrode, only the second sub pressure detection electrode 220b may be utilized as a pressure detection electrode, and thus a pressure based on a change in a distance between the second sub pressure detection electrode 220b and the cover case may be detected.

The second sub pressure detection electrode 220b may be provided to be spaced apart from the first side support 1210. The second sub pressure detection electrode 220b may be provided to be spaced apart from an upper surface of the first side support 1210. For example, a distance between the second sub pressure detection electrode 220b and the upper surface of the first side support 1210 may be about 50 μm or more. When the distance between the second sub pressure detection electrode 220b and the upper surface of the first side support 1210, which may be spaced apart from each other, is less than 50 μm, a change in a pressure based on a distance difference between the second sub pressure detection electrode 220b and the upper surface of the first side support 1210 may not be effectively detected due to a small distance difference, thereby degrading sensitivity.

The first sub pressure detection electrode 220a and the second sub pressure detection electrode 220b may be protected by the protective layer 230. The protective layer 230 may be provided to surround the first sub pressure detection electrode 220a and the second sub pressure detection electrode 220b, and accordingly, damage or deformation of the first sub pressure detection electrode 220a and the second sub pressure detection electrode 220b exposed to the outside may be prevented. The protective layer 230 may include a material which is the same as or similar to that of the insulating layer 900.

The adhesive layer 500 may be provided on an upper surface of the second side support 1220. The adhesive layer 500 may have elasticity. The adhesive layer 500 may be an elastic adhesion layer. For example, the adhesive layer 500 may include a silicone resin or the like. The adhesive layer 500 may be a foam tape. The adhesive layer 500 may be provided to be adhered to the protective layer 230. The pressure detection member 200 may be fixed inside the cover case 1000 by the adhesive layer 500.

The pressure detection electrode 220 may detect a pressure of an input device in contact with a surface of the substrate 100. The substrate 100 may include a first surface 100a and a second surface 100b. When an input device comes into contact with the first surface 100a of the substrate 100, a pressure based on the contact of the input device may be detected according to a change in the distance between the second sub pressure detection electrode 220b and the upper surface of the first side support 1210.

The pressure detection electrode 220 may be driven by a self-cap method or a mutual-cap method. For example, the pressure detection electrode 220 may be driven by the self-cap method. At this time, the first sub pressure detection electrode 220a may serve as a ground electrode which blocks external noise and detects a pressure based on a contact of an input device on the basis of a change in the distance between the second sub pressure detection electrode 220b and the upper surface of the first side support 1210.

Alternatively, the pressure detection electrode 220 may be driven by the mutual-cap method. A pressure based on a contact of an input device may be detected by the first sub pressure detection electrode 220a and the second sub pressure detection electrode 220b. The second sub pressure detection electrode 220b may detect a pressure based on the contact of the input device on the basis of a change in the distance between the second sub pressure detection electrode 220b and the upper surface of the first side support 1210. The first sub pressure detection electrode 220a may serve as an electrode which receives such a signal.

The first sub pressure detection electrode 220a and the second sub pressure detection electrode 220b may include an electromagnetic resonance (EMR) electrode. The EMR electrode may be formed as an electrode in various shapes such as a loop shape, a coil shape, a spiral shape, etc. When the first sub pressure detection electrode 220a and the second sub pressure detection electrode 220b include an EMR electrode and an input device applies pressure to a surface of the substrate, a distance between the pressure detection electrode and the upper surface of the first side support 1210 is changed, and a resonance frequency of the first sub pressure detection electrode 220a and the second sub pressure detection electrode 220b may be changed according to the changed value.

Based on the change in the distance between the pressure detection electrode and the upper surface of the first side support 1210, a capacitance C and inductance L of each of the first sub pressure detection electrode 220a and the second sub pressure detection electrode 220b are changed. Accordingly, a magnitude of a pressure based on an intensity of a pressure and a direction in which the pressure is applied are detected, and thus a pressure based on the contact of the input device may be detected. Here, the first side support 1210, i.e., the cover case, may be grounded and may serve as a ground electrode.

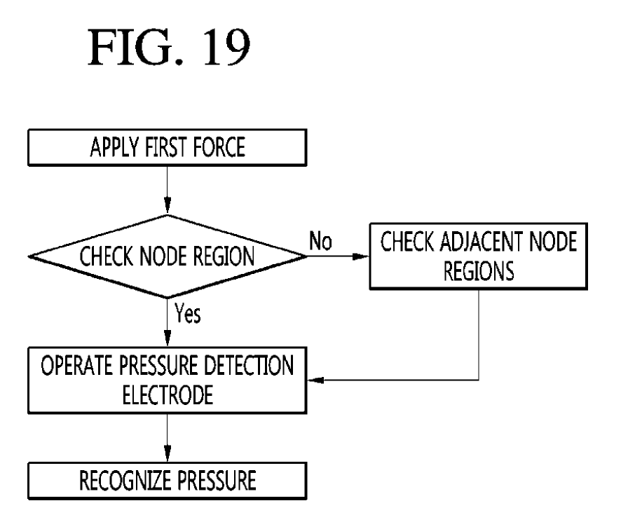

FIG. 19 is a flowchart for detecting a pressure in a case in which an input device comes into contact with one node region among a plurality of node regions or applies a force to the one node region. Referring to FIG. 10, first, an input device may apply a first force to one node region among the plurality of node regions N formed by the first touch detection electrode 810 and the second touch detection electrode 820. Then, a location of the node region N may be detected by the first touch detection electrode 810 and the second touch detection electrode 820. Then, whether another force is applied to node regions adjacent to the contacted node region is determined, and when another force is not applied thereto, the pressure detection electrodes may be activated.

The first pressure detection electrodes 221 and the second pressure detection electrodes 222 provided in an ineffective region of regions corresponding to first extension lines and second extension lines which pass through the node region may be activated, and a first pressure based on the first force may be detected by the first pressure detection electrodes 221 and the second pressure detection electrodes 222.

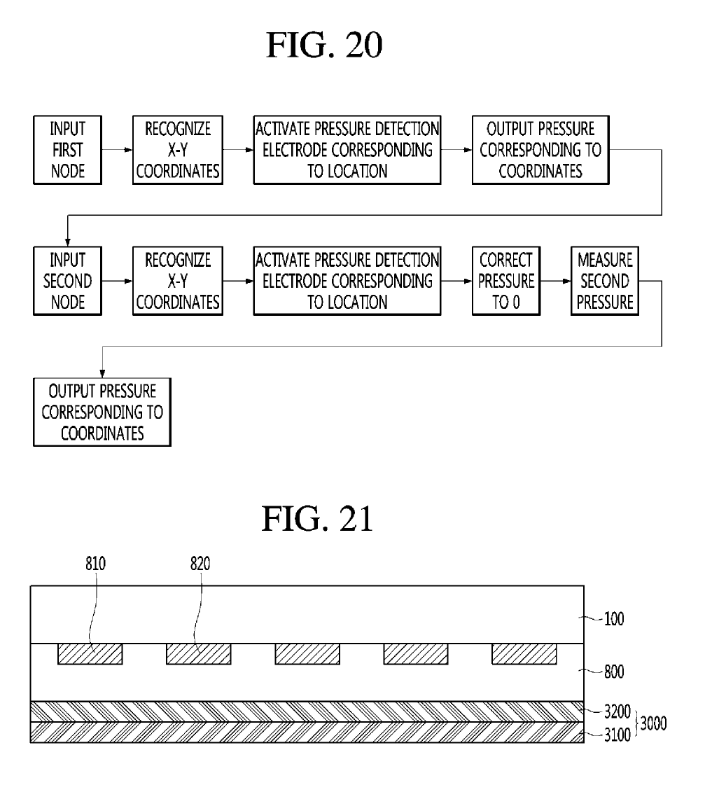

FIG. 20 is a flowchart for detecting a pressure in a case in which an input device comes into contact with multiple node regions among a plurality of node regions or applies a force to the multiple node regions. Referring to FIG. 20, first, an input device applies a first force to a first node region N1 among the plurality of node regions N formed by the first touch detection electrode 810 and the second touch detection electrode 820. Then, a location of the first node region N1 may be detected by the first touch detection electrode 810 and the second touch detection electrode 820. Then, the pressure detection electrodes may be activated by a force applied to the first node region N1.

The first pressure detection electrodes 221 and the second pressure detection electrodes 222 provided in an ineffective region of regions corresponding to first extension lines and second extension lines which pass through the first node region N1 may be activated, and a first pressure based on the first force may be detected by the first pressure detection electrodes 221 and the second pressure detection electrodes 222. Then, the input device may apply a second force to a second node region N2 which is different from the first node region N1 among the plurality of node regions N. Then, the pressure detection electrodes may be activated by the second force applied to the second node region N2.

First, an intensity of a pressure measured by the first force is corrected to zero, and then a second pressure based on the second force may be measured. The first pressure detection electrodes 221 and the second pressure detection electrodes 222 provided in an ineffective region of regions corresponding to first extension lines and second extension lines which pass through the second node region N2 may be activated, and the second pressure based on the second force may be detected by the first pressure detection electrodes 221 and the second pressure detection electrodes 222.

In the touch device according to the second embodiment, an electrode configured to detect pressure may be directly provided on a substrate. A pressure detection electrode may be provided in an ineffective region of the substrate. Accordingly, the substrate and the pressure detection electrode may be integrated.

In the touch device according to the second embodiment, a separate pressure detection layer configured to detect pressure can be omitted. Accordingly, an increase in a thickness of a touch device including a separate pressure detection layer may be prevented, and thus a slim touch device can be made. Since a location of a touch detection electrode is not limited by a pressure detection electrode being provided in an ineffective region of a substrate, various types of touch devices may be made.

Different pressure detection electrodes may be activated according to coordinates recognized by a touch detection electrode, and thus the touch device may detect a pressure of each electrode on the basis of a force applied to a substrate. When pressures are detected at different locations, the pressures may be detected by different pressure detection electrodes. Accordingly, when a touch and force are applied to two regions, a pressure applied to each region can be easily detected. Since a pressure based on a second force is detected after a pressure based on a first force is corrected to zero, an intensity of pressure can be detected more accurately.

Referring to FIG. 21 to FIG. 23, the touch electrodes may be provided at various locations. Referring to FIG. 21, the first touch detection electrode 810 and the second touch detection electrode 820 may be provided on the same surface. The first touch detection electrode 810 and the second touch detection electrode 820 may be provided on the same surface of the substrate 100. The first touch detection electrode 810 and the second touch detection electrode 820 may be provided to be in direct or indirect contact with the substrate 100.

Since the first touch detection electrode 810 and the second touch detection electrode 820 are provided on the same surface of the substrate 100, a thickness of the entire touch device may be reduced. The substrate 100 may be adhered to the display panel 3000 by an adhesive material 800.

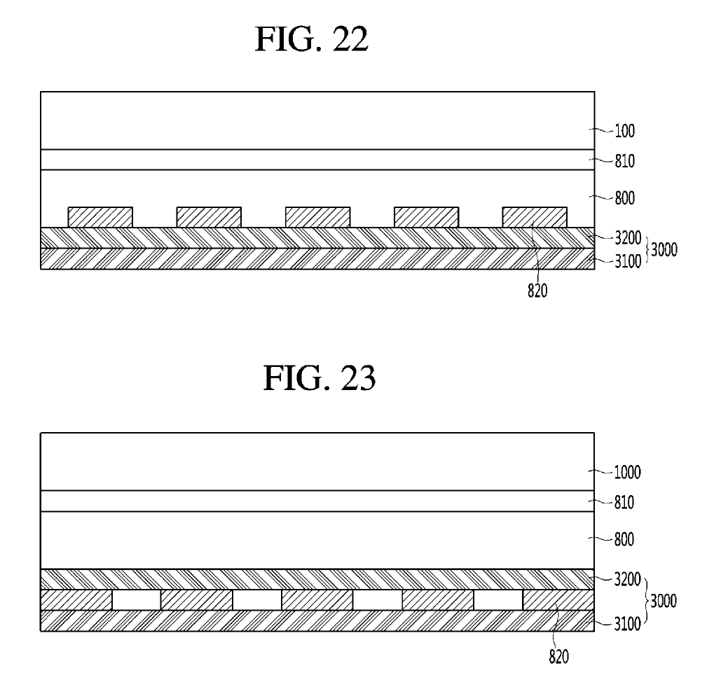

Referring to FIG. 22 and FIG. 23, the second touch detection electrode 820 may be provided on the display panel 3000 or inside the display panel 3000. The substrate 100 and the display panel 3000 may be adhered to each other by the adhesive material 800, and the second touch detection electrode 820 may be provided on the display panel 3000 or inside the display panel 3000. The second touch detection electrode 820 may be provided to be in contact with the display panel 3000.

Referring to FIG. 22, the first touch detection electrode 810 may be provided in direct or indirect contact with a surface of the substrate 100. The second touch detection electrode 820 may be provided on the display panel 3000. The second touch detection electrode 820 may be provided in direct or indirect contact with a surface of the second substrate 3200.

Alternatively, referring to FIG. 23, the first touch detection electrode 810 may be provided in direct or indirect contact with a surface of the substrate 100. The second touch detection electrode 820 may be provided inside the display panel 3000. The second touch detection electrode 820 may be interposed between the first substrate 3100 and the second substrate 3200. Since a separate substrate for supporting the second touch detection electrode 820 is not needed, a touch device having a slimmer thickness can be made.

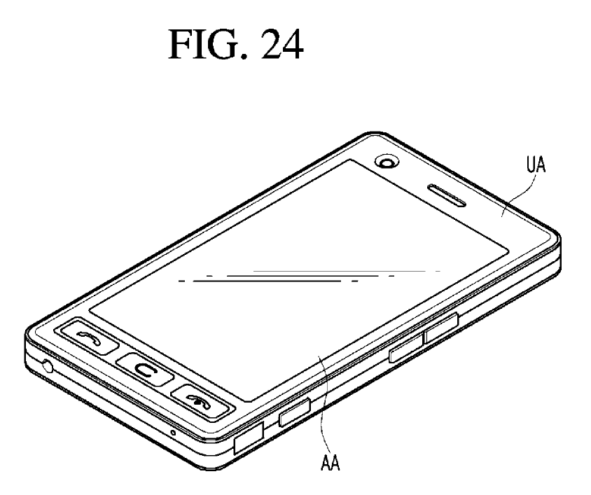

Examples of a display device to which the touch device according to the above-described embodiments may be applied are described with reference to FIG. 24 to FIG. 28. FIG. 24 is an example of a touch device which illustrates a portable terminal. The portable terminal may include an effective region AA and an ineffective region UA. A touch signal may be detected in the effective region AA when a finger or the like touches the effective region AA, and a command icon pattern, a logo, and the like may be formed in the ineffective region.

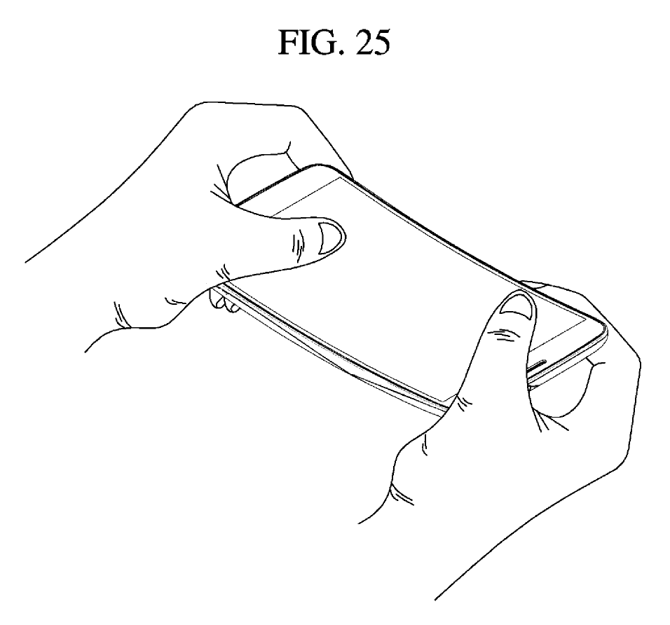

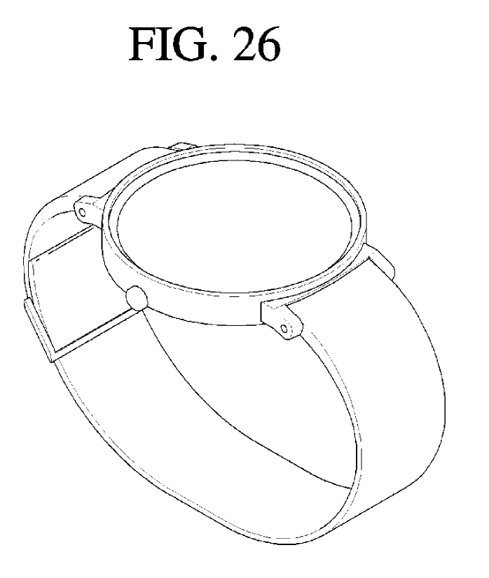

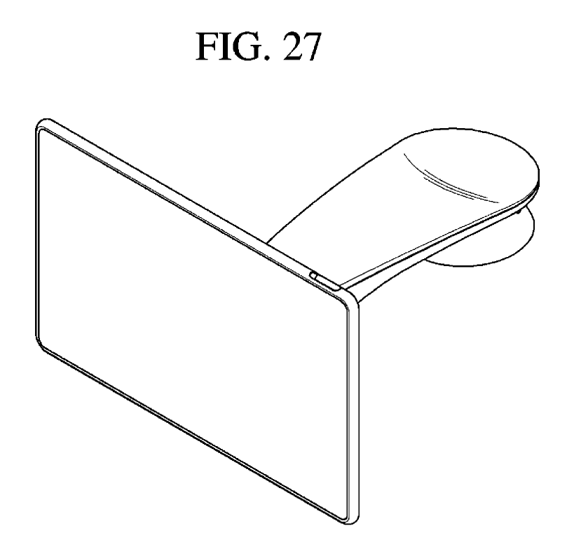

Referring to FIG. 25 and FIG. 26, a touch device may include a flexible device that may be flexible. Accordingly, the touch device including the flexible device may be a flexible touch device. The touch device may be curved or bent by a user's hand. Such a flexible touch device may be applied to a wearable touch device such as a smart watch or the like.

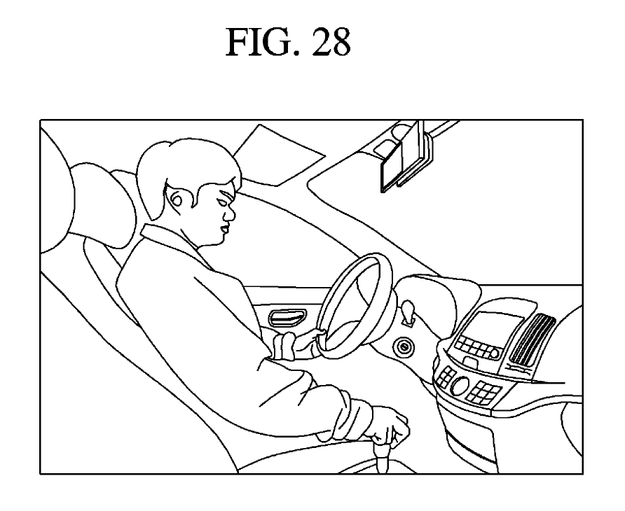

Referring to FIG. 27, such a touch device may be applied to a vehicle navigation system in addition to a portable terminal or the like including the touch device. Referring to FIG. 28, such a touch device may be applied inside a vehicle. The touch device may be applied to various portions, to which the touch device may be applied, in the vehicle. Accordingly, the touch device may be applied to a dashboard and the like to implement a center information display (CID) in addition to being applied to a personal navigation display (PND). However, the embodiment is not limited thereto, and such a touch device may also be used for various electronic products.

According to embodiments disclosed herein, a touch window may include a substrate including an effective region and an ineffective region, and a plurality of pressure detection members provided in the ineffective region, wherein the pressure detection members may be provided to be spaced apart from each other, and each of the pressure detection members may include a strain gauge or a capacitance detection electrode.

According to embodiments disclosed herein, a touch window may icnlude a substrate accommodated in a cover case and including an effective region and an ineffective region, and at least one pressure detection member provided in the ineffective region, wherein the pressure detection member may include a base substrate, an electrode provided on the base substrate, and a protective layer provided on the electrode.

In the touch window according to embodiments, an electrode configured to detect a pressure may be directly provided on the substrate. The pressure detection electrode may be provided in the ineffective region of the substrate. The substrate and the pressure detection electrode may be integrated. Accordingly, a separate pressure detect layer configured to detect a pressure may be omitted. Accordingly, an increase in a thickness of a touch device due to the separate pressure detection layer may be prevented, and thus a slim touch device may be made. Since a location of a touch detection electrode is not limited by a pressure detection electrode being provided in an ineffective region of a substrate, various types of touch devices maybe made.

According to embodiments disclosed herein, there is provided a touch window including a substrate accommodated in a cover case and including an effective region and an ineffective region, a touch detection electrode provided in the effective region; and at least one pressure detection electrode provided in the ineffective region, wherein the touch detection electrode includes a first touch detection electrode configured to extend in one direction, and a second touch detection electrode configured to extend in another direction that is different the one direction of the first touch detection electrode, wherein the first touch detection electrode and the second touch detection electrode intersect and form a node region, and the pressure detection electrode may be provided at a location corresponding to an extension line of the node region in the ineffective region.

Further, different pressure detection electrodes may be activated according to coordinates recognized by the touch detection electrode, and thus the touch device may detect a pressure of each electrode on the basis of a force applied to the substrate. When pressures are detected at different locations, the pressures may be detected by different pressure detection electrodes. Accordingly, when a touch and force are applied to two regions, a pressure applied to each region may be easily detected. Since a pressure based on a second force is detected after a pressure based on a first force is corrected to zero, an intensity of the pressure can be detected more accurately.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch window comprising:
a substrate including an effective region and an ineffective region; and
a plurality of pressure detection members provided in the ineffective region,
wherein the pressure detection members are provided to be spaced apart from each other, and each of the pressure detection members includes a strain gauge or a capacitance detection electrode.

2. The touch window of claim 1, wherein:
the substrate includes a plurality of corner regions; and
the pressure detection members are provided in at least one corner region among the corner regions.

3. The touch window of claim 1, wherein the pressure detection members are provided to extend along an edge region of the substrate.

4. The touch window of claim 1, wherein each of the pressure detection members includes:
a base substrate;
a pressure electrode provided on the base substrate; and
a protective layer provided on the pressure electrode.

5. The touch window of claim 1, further comprising a deco layer provided in the ineffective region, wherein the pressure detection members are provided on the deco layer.

6. The touch window of claim 1, further comprising a touch electrode provided in the effective region.

7. The touch window of claim 1, wherein:
a plurality of grooves are formed in the substrate; and
the pressure detection members are provided inside the plurality of grooves.

8. The touch window of claim 7, wherein:
the substrate includes a first surface to which an input device applies a force and a second surface opposite the first surface;
the plurality of grooves are formed in the second surface; and
a distance from a lower surface of each of the plurality of grooves to the first surface is in a range of about 100 μm to 300 μm.

9. The touch window of claim 1, wherein:
the substrate is accommodated in a cover case;
a touch detection electrode is provided in the effective region;
a pressure detection electrode is provided in the ineffective region;
the touch detection electrode includes a plurality of node regions spaced apart from each other in a matrix form; and
the pressure detection electrode is provided in the ineffective region at a location corresponding to an extension line of the node region.

10. The touch window of claim 9, wherein the touch detection electrode includes:
a first touch detection electrode configured to extend in one direction; and
a second touch detection electrode configured to extend in another direction that is different the one direction of the first touch detection electrode,
wherein the first touch detection electrode and the second touch detection electrode intersect and form the node region.

11. The touch window of claim 10, wherein the first touch detection electrode and the second touch detection electrode are provided on a surface of the substrate.

12. The touch window of claim 9, wherein:
the extension line of the node region includes:
a plurality of first extension lines configured to extend in a direction in which the first detection electrode extends; and
a plurality of second extension lines configured to extend in a direction in which the second detection electrode extends, and
the pressure detection electrode includes:
a plurality of first pressure detection electrodes provided in a region corresponding to the first extension lines; and
a plurality of second pressure detection electrodes provided in a region corresponding to the second extension lines.

13. The touch window of claim 9, wherein the substrate includes a first surface to which an input device applies a force and a second surface opposite the first surface.

14. The touch window of claim 9, wherein:
the node region includes a first node region and a second node region which are spaced apart from each other; and
when an input device applies a force to the first node region, a first pressure is detected by a first pressure detection electrode and a second pressure detection electrode provided in a region corresponding to a first extension line and a second extension line which pass through the first node region.

15. The touch window of claim 9, wherein, when an input device simultaneously applies a force to a first node region and a second node region, a second pressure is detected by a first pressure detection electrode and a second pressure detection electrode provided in a region corresponding to a first extension line and a second extension line which pass through the second node region.

16. The touch window of claim 15, wherein a first pressure is corrected to zero before the second pressure is detected.

17. The touch window of claim 9, wherein the substrate includes a cover substrate.
